(19) United States
(12) Patent Application Publication
(10) Pub. No.: US 2010/0241343 A1
(43) Pub. Date: Sep. 23, 2010

(54) APPARATUS AND METHOD FOR RECOGNIZING TRAFFIC LINE

(75) Inventors: Jaemin BYUN, Daejeon (KR); Myung Chan ROH, Daejeon (KR); Junyong SUNG, Daejeon (KR); Sung Hoon KIM, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/572,355

(22) Filed: Oct. 2, 2009

(30) Foreign Application Priority Data
Mar. 20, 2009 (KR) 10-2009-0023988

(51) Int. Cl. G08G 1/00; G06K 9/00

(52) U.S. Cl. 701/117; 382/103; 382/107

(57) ABSTRACT

An apparatus for recognizing traffic lines on a roadway includes an image division unit for dividing an image of the roadway into a specific number of areas; a traffic line detection unit for detecting a traffic line from the respective divided areas of the roadway images; a traffic line representation unit for obtaining a traffic line equation representing the traffic line in the detected traffic line; a location detection unit for detecting a current location of a vehicle using movement direction and velocity of the vehicle sensed by a location detector; and a traffic line prediction unit for predicting a location of the traffic line to be displaced, using the detected current location, and the movement direction and velocity of the vehicle on a basis of traffic line equation.

### CROSS-REFERENCE(S) TO RELATED APPLICATION(S)

The present invention claims priority of Korean Patent Applications No. 10-2009-0023988, filed on Mar. 20, 2009, which is incorporated herein by reference.

### FIELD OF THE INVENTION

The present invention relates to an apparatus and method for recognizing a traffic line, and more particularly, to an apparatus and method for recognizing a traffic line by predicting the location of the traffic line.

### BACKGROUND OF THE INVENTION

As well known to those skilled in the art, a technique for detecting a traffic line using an image recognizer in outdoor road environments is directly related to the self-control traveling of an automated guided vehicle. Such an automated guided vehicle is configured to automatically travel by adjusting the brake, accelerator and steering gear of the vehicle according to the external environment recognized by sensors. In general, the schemes of the automated guided vehicle are classified into a scheme using a Radio Frequency (RF) transceiver and a scheme using a monitoring camera.

Further, traffic line detection technologies directly related to the self-control traveling of an automated guided vehicle are implemented using technologies which extract edges using a Sobel filter, a Laplacian filter, etc. and detect the location of traffic lines using the extracted edges, that is, location diction technologies. For these technologies, various methods using a Global Positioning System (GPS) and an inertial navigation device have recently been presented, and a lot of research into new methods using sensor fusion is currently being conducted.

However, among the above-described techniques, technologies using a Sobel filter, a Laplacian filter are disadvantageous in that they are very vulnerable to noise.

Further, the traffic line detection techniques are disadvantageous in that, since many cameras are used and, in particular, high-resolution cameras are required, economic burden may increase, and in that, since a lot of processing time is required due to complicated detection algorithms. Therefore, it is difficult to use these techniques. Furthermore, there are disadvantages in that, when an automated guided vehicle passes through a tunnel, or travels in an environment in which the weather suddenly changes as in the case of heavy snowfall or heavy rainfall, there occurs the situation in which the traffic lines are actually present, but they cannot be identified because a screen instantaneously becomes white due to the saturation of the light quantity of a camera, and the situation in which instantaneous erroneous detection is performed due to the degradation of image information captured by the camera, thus resulting in danger to the traveling of the automated guided vehicle.

### SUMMARY OF THE INVENTION

In view of the above, the present invention provides an apparatus and method for recognizing a traffic line zone even when traveling is conducted in an environment in which the weather suddenly changes.

In accordance with an aspect of the present invention, there is provided an apparatus for recognizing traffic lines on a roadway, including:

an image division unit for dividing an image of the roadway captured by a camera into a specific number of areas;

a traffic line detection unit for detecting a traffic line from the respective divided areas of the roadway images;

a traffic line representation unit for obtaining a traffic line equation representing the traffic line in the detected traffic line;

a location detection unit for detecting a current location of a vehicle using movement direction and velocity of the vehicle sensed by a location detector; and

a traffic line prediction unit for predicting a location of the traffic line to be displaced, using the detected current location, and the movement direction and velocity of the vehicle on a basis of traffic line equation.

In accordance with an aspect of the present invention, there is provided a method of recognizing traffic lines on a roadway, including:

sensing movement direction and velocity of a vehicle on the roadway using a location detector;

obtaining a roadway image having the traffic lines;

dividing the roadway image into a plurality of areas;

extracting traffic line zones from the respective areas of the roadway image;

obtaining a traffic line equation for representing the traffic line in the extracted traffic line zones; and

predicting a location of the traffic line to be displaced in subsequent roadway image, using the current position, movement direction, and velocity based on the traffic line equation.

### BRIEF DESCRIPTION OF THE DRAWINGS

The above and other objects and features of the present invention will become apparent from the following description of preferred embodiments given in conjunction with the accompanying drawings, in which:

FIG. 1 is a block diagram showing an apparatus for recognizing a traffic line according to an embodiment of the present invention;

FIG. 2 is a detailed block diagram showing the traffic line detection unit of FIG. 1;

FIG. 3 is a detailed block diagram showing the representation unit of FIG. 1;

FIG. 4 is a flowchart sequentially showing a method of recognizing a traffic line according to an embodiment of the present invention;

FIG. 5 is a diagram showing a roadway image divided into four areas by the image division unit of FIG. 1; and

FIG. 6 is a diagram showing the determination of a search range established through the prediction of traffic lines to be displaced using the traffic line prediction unit of FIG. 1.

### DETAILED DESCRIPTION OF THE EMBODIMENTS

Hereinafter, exemplary embodiments of the present invention will be described in detail with reference to the accompanying drawings.

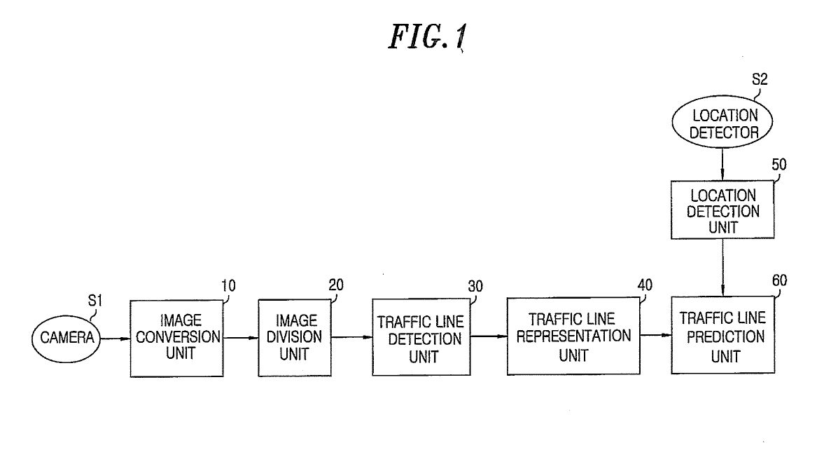

FIG. 1 is a block diagram showing an apparatus for recognizing a traffic line according to an embodiment of the present invention. The traffic line recognition apparatus, which is mounted in a vehicle, includes an image conversion unit 10, an image division unit 20, a traffic line detection unit 30, a traffic line representation unit 40, a location detection unit 50, and a traffic line prediction unit GO.

A camera S1 captures a surface of a roadway to obtain a roadway image in color. The image conversion unit 10 receives the roadway image in color captured by the camera S1, and converts the roadway image in color into a roadway image in gray. The roadway image in gray is suitable to easily recognize a traffic line from a roadway using a difference in brightness in the roadway image in gray, thereby enabling to reduce processing time. The roadway image in gray is then provided to the image division unit 20.

Alternatively, if the roadway image obtained by the camera S1 is a grey image, the image conversion unit 10 may be removed in the traffic line recognition apparatus of the present invention. In this case, the roadway image in gray may be directly provided to the image division unit 20.

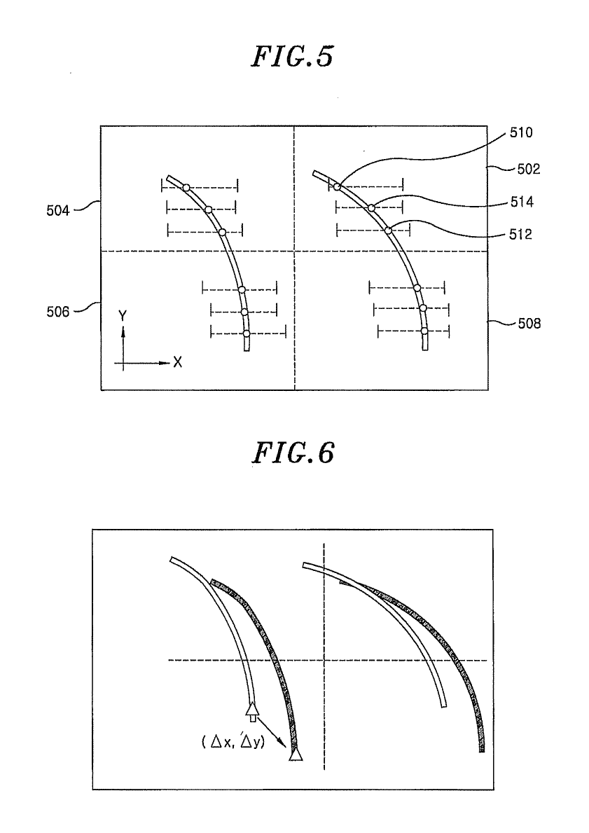

The image division unit 20 divides the roadway image in gray into a plurality of image areas, e.g., first to fourth quadrants 502, 504, 506 and 508 as shown in FIG. 5. The divided four image areas are provided to the traffic line detection unit 30.

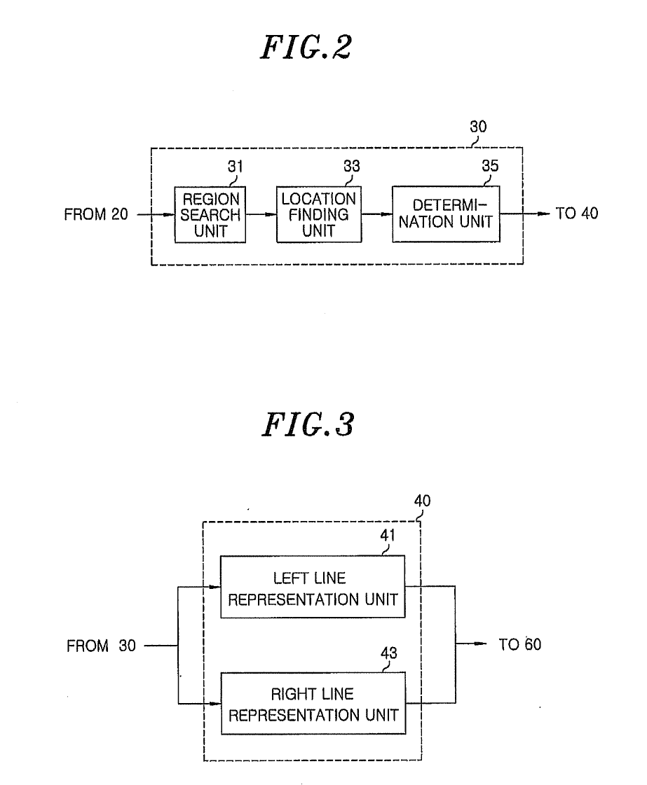

The traffic line detection unit 30 serves to detect the traffic line in the four image areas. The traffic line detection unit 30 includes a region search unit 31, a location finding unit 33 and a determination unit 35, as shown in FIG. 2.

The region search unit 31 establishes three search regions in each of the four image areas to extract a traffic line zone having a difference in brightness. For example, in FIG. 5, each of the four image areas, e.g., a first quadrant image 502 is partitioned into three regions with different heights in the direction of a Y-axis (for example, a vertical axis) thereof. And then, a traffic line zone in which a difference in brightness is greater than a threshold and whose width is greater than a predetermined width in the direction of an X-axis (for example, a lateral axis) is searched in each region.

The location finding unit 33 finds the location of center points of the traffic line zones searched by the region search unit 31 to provide the center points to the determination unit 35.

The traffic line determination unit 35 obtains a straight line passing through the uppermost center point and the lowermost center point in the direction of a Y-axis (for example, a vertical axis) in each quadrant image, and determines whether an intermediate center point of the three center points exists on the straight line. If it is determined that the intermediate center point exists on the straight line, the traffic line determination unit 35 recognizes the straight line as a traffic line passing through three center points. If, however, it is determined that the intermediate center point is deviated from the straight line, the traffic line determination unit 35 determines that a distance spaced apart from the straight line in the X-axis direction falls within a preset error range. If it is determined that the distance falls within the preset error range, the determination unit 35 also recognizes the straight line as a traffic line passing through three center points.

However, if the distance does not fall within the preset error range, the region search unit 31 repeats from the operation of the partition of each quadrant image into the three regions with different heights as described above.

The traffic line determination unit 35 provides the recognized traffic line for each quadrant image to the traffic line representation unit 40.

The traffic line representation unit 40 represents left and right traffic lines by obtaining equations of the left and right traffic lines. As shown in FIG. 3, the traffic line representation unit 40 includes a left traffic line representation unit 41 and a right traffic line representation unit 43.

The left traffic line representation unit 41 obtains a left traffic line equation using six center points located in a left half including the second and third quadrant images 504 and 506 of the roadway image so as to represent a left traffic line, and provides the left traffic line equation to the traffic line prediction unit 60.

The right traffic line representation unit 43 obtains a right traffic line equation using six center points located in a right half including the first and fourth quadrants 502 and 508 of the roadway image so as to represent a right traffic line in the roadway image, and provides the right traffic line equation to the traffic line prediction unit 60.

Meanwhile, the location detection unit 50 is configured to detect a current location of the vehicle on the roadway using movement direction and velocity of the vehicle, which are sensed by a location detector S2, for example, a Differential Global Positioning System (DGPS), an internal rotary encoder, a gyroscope, a digital compass sensor, etc. The current location, the movement direction and velocity of the vehicle are provided in real time to the traffic line prediction unit 60.

The traffic line prediction unit 60 calculates a degree and direction, by which the left and right traffic lines will be displaced in an image coordinate system, using the current location, movement direction and velocity on a basis of the left and right traffic line equations, to thereby predict the locations of the left and right traffic lines to be displaced by displacements Δx and Δy from the left and right traffic lines which was predicted previously as shown in FIG. 6.

The prediction of the traffic lines enables to optimize the establishment of the search range to search the traffic lines in subsequent road images.

Therefore, it is possible to prevent roadway image from being distorted and a traffic line from being erroneously detected due to sudden variation in the traveling environment, and enable a traffic line to be accurately detected even when traveling in an environment in which the weather suddenly changes.

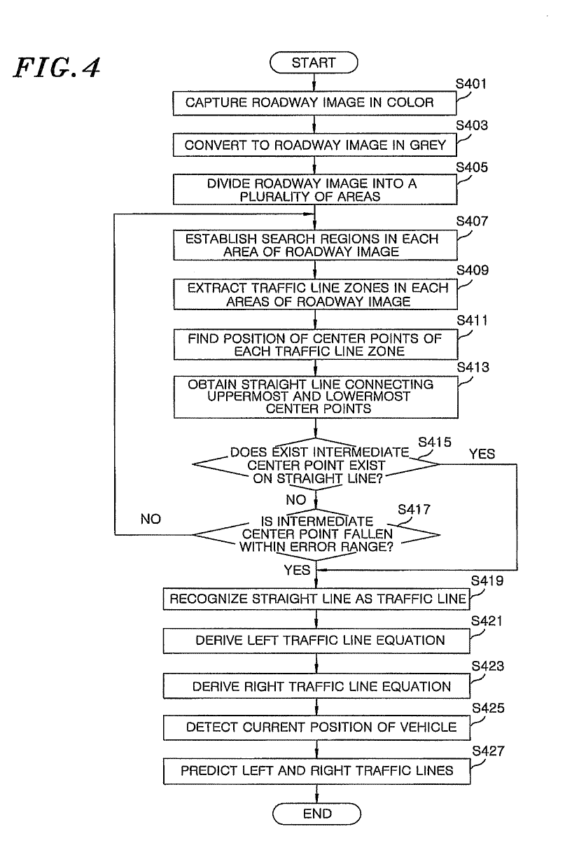

A traffic line recognition process performed by the traffic line recognition apparatus according to the embodiment of the present invention having the above configuration will be described in detail with reference to FIG. 4 as follows.

FIG. 4 is a flowchart sequentially showing a method of recognition a traffic line according to an embodiment of the present invention.

First, a roadway image in color captured by the camera S1 is provided to the image conversion unit 10 at step S401. Next, the roadway image in color is converted into a roadway image in gray by the image conversion unit 10 so as to easily separate traffic lines from the roadway image at step S403. The roadway image in gray is then provided to the image division unit 20.

The roadway image in gray is partitioned into four areas corresponding to first to fourth quadrants, as shown in FIG. 5, at step S405. The roadway image of the first to fourth quadrants is then provided to the traffic line detection unit 30.

In the traffic line detection unit 30, the region search unit 31 establishes three search regions having different heights in a Y-axis direction in each roadway image of the first to four quadrants at step S407.

Thereafter, the region search unit 31 searches the three search regions to extract traffic line zones in which a difference in brightness is greater than a threshold and whose width is greater than a preset width in the direction of an X-axis in the search regions at step S409. The extracted traffic line zones are then provided to the location finding unit 33.

The location finding unit 33 finds the locations of the center points of the extracted traffic line zones provided from the range search unit 31, and provides the locations of the center points to the determination unit 35 at step S411.

The traffic line determination unit 35 obtains a straight line passing through both the uppermost center point 510 and the lowermost center point 512 in the direction of a Y-axis at step S413, and determines whether or not an intermediate center point 514 exists on the straight line at step S415.

If it is determined at step S415 that the intermediate center point 514 exists on the straight line, a control process goes to step S419 where the straight line is recognized as a traffic line passing through three center points 510, 512 and 514.

If, however, at step S415, it is determined that the intermediate center point 514 is deviated from the straight line, a control process advances to step S417 where the traffic line determination unit 35 determines that a distance, by which the intermediate center point 514 is spaced apart from the straight line, falls within a preset error range. If it is determined that the distance falls within the preset error range, the straight line is also recognized as a traffic line passing through three center points as in step S419. In contrast, if it is determined at step S417 that the distance does not fall within the preset error range, the straight line is not recognized as a traffic line passing through three center points, and thus the control process returns to step S407 to repeat the establishment of the search regions. After the recognition of the straight line as the traffic line passing through three points, the recognized traffic line is provided to the left traffic line representation unit 41 and the right traffic line representation unit 43 of the representation unit 40.

The left traffic line representation unit 41 obtains a left traffic line equation using six points located in the second and third quadrants as shown in FIG. 5 so as to represent a left traffic line, and provides the obtained left traffic line equation to the traffic line prediction unit 60 at step S421.

The right traffic line representation unit 43 obtains a right traffic line equation using six points located in the first and fourth quadrants of FIG. 5 so as to represent a right traffic line, and provides the obtained right traffic line equation to the traffic line prediction unit 60 at step S423.

Meanwhile, the location detection unit 50 detects the current location of the vehicle on the roadway using movement direction and velocity of the vehicle sensed by the location detector S2, and provides the detected current location, the movement direction and velocity of the vehicle in real time to the traffic line prediction unit 60 at step S425.

The traffic line prediction unit 60 predicts locations of the left and right traffic lines to be displaced in the directions of Δx and Δy from a previous left and right traffic lines, as shown in FIG. 6, at step S427. The predicted locations of the left and right traffic lines on the roadway will be referenced for the establishment of search ranges used to recognize a traffic line in subsequent roadway images.

The method of detecting a traffic line may be implemented in the form of a computer software program. The codes and code segments constituting the computer software program may be easily deduced by computer programmers skilled in the art. Further, the computer software program is stored in computer-readable media and is read and executed by a computer, so that the traffic line detection method is implemented. The computer-readable media include magnetic recording media, optical recording media, and carrier wave media.

As described above, according to the present invention, it is possible to predict the time-variation in the locations of curve equations representing traffic lines in an image coordinate system to minimize regions for detecting traffic lines, thus remarkably reducing processing time.

While the invention has been shown and described with respect to the particular embodiments, it will be understood by those skilled in the art that various changes and modification may be made without departing from the scope of the invention as defined in the following claims.

What is claimed is:

1. An apparatus for recognizing traffic lines on a roadway, comprising:
an image division unit for dividing an image of the roadway captured by a camera into a specific number of areas;
a traffic line detection unit for detecting a traffic line from the respective divided areas of the roadway images;
a traffic line representation unit for obtaining a traffic line equation representing the traffic line in the detected traffic line;
a location detection unit for detecting a current location of a vehicle using movement direction and velocity of the vehicle sensed by a location detector; and
a traffic line prediction unit for predicting a location of the traffic line to be displaced, using the detected current location, and the movement direction and velocity of the vehicle on a basis of traffic line equation.

2. The apparatus of claim 1, wherein the traffic line detection unit comprises:
a region search unit for searching each area of the roadway image to acquire traffic line zones in which a difference in brightness is greater than a threshold and whose width is greater than a preset width in a lateral direction in each area of the roadway image;
a location finding unit for finding locations of center points of the found traffic line zones; and
a traffic line determination unit for obtaining a straight line passing through an uppermost center point and a lowermost center point in the center points, and recognizing the straight line as the traffic line when an intermediate center point in the center points exist on the straight line.

3. The apparatus of claim 2, wherein the region search unit establishes traffic line search regions having search ranges with a plurality of different heights in each divided area of the roadway image.

4. The apparatus of claim 2, wherein the traffic line representation unit comprises:
a left traffic line representation unit for obtaining a left traffic line equation using center points detected in left half of the roadway image; and
a right traffic line representation unit for obtaining a right traffic line equation using the center points detected in right half of the roadway image.

5. The apparatus of claim 4, wherein the left half of the roadway image includes second and third quadrants of the roadway image.

6. The apparatus of claim 5, wherein the left traffic line equation is derived from a straight line obtained by connecting center points located in the second quadrant to center points located in the third quadrant.

7. The apparatus of claim 4, wherein the right half of the roadway image includes first and fourth quadrants of the roadway image.

8. The apparatus of claim 7, wherein the right traffic line equation is derived from a straight line obtained by connecting center points located in the first quadrant to center points located in the fourth quadrant.

9. The apparatus of claim 3, wherein the predicted traffic line is referenced to establish the search range to search the traffic lines in subsequent road images.

10. The apparatus of claim 1, wherein the location detector is any one of a Differential Global Positioning System (DGPS), a rotary encoder, a gyroscope, and a digital compass sensor.

11. A method of recognizing traffic lines on a roadway comprising:
sensing movement direction and velocity of a vehicle on the roadway using a location detector;
obtaining a roadway image having the traffic lines;
dividing the roadway image into a plurality of areas;
extracting traffic line zones from the respective areas of the roadway image;
obtaining a traffic line equation for representing the traffic line in the extracted traffic line zones; and
predicting a location of the traffic line to be displaced in subsequent roadway image, using the current position, movement direction, and velocity based on the traffic line equation.

12. The method of claim 11, wherein said extracting the traffic line zones comprises:
searching search ranges in each of the respective divided areas of the roadway image to acquire the traffic line zones in which a difference in brightness is greater than a threshold and whose width greater than a preset width in the respective divided areas;
finding a location of center points of the acquired traffic line zones;
obtaining a straight line passing through an uppermost center point and a lowermost center point in the center points; and
if an intermediate center point in the center points exists on the straight line, recognizing the straight line as the traffic line.

13. The method of claim 12, wherein the search ranges are established by traffic line search regions with a plurality of different heights in each divided area of a previous roadway image.

14. The method of claim 12, wherein said obtaining the traffic line comprises:
obtaining a left traffic line equation using center points located in left half of the roadway image; and
obtaining a right traffic line equation using center points located in right half of the roadway image.

15. The method of claim 14, wherein the left half of the roadway image includes are second and third quadrants of the roadway image.

16. The method of claim 15, wherein the left traffic line equation is derived from a straight line obtained by connecting center points located in the second quadrant to center points located in the third quadrant.

17. The method of claim 14, wherein the right half of the roadway image includes first and fourth quadrants of the roadway image.

18. The method of claim 17, wherein the right traffic line equation is derived from a straight line obtained by connecting center points located in the first quadrant to center points located in the fourth quadrant.

19. The method of claim 11, wherein the predicted traffic line is used to establish the search range to search the traffic lines in subsequent road images.

20. The method of claim 11, further comprising:
if a mediate center point in the center points is deviated from the straight line, determining a distance that the intermediate center point is spaced apart from the straight line falls within a preset error range;
if the distance falls within the preset error range, recognizing the straight line as a traffic line passing through three center points; and
if the distance does not fall within the preset error range, repeating from said searching the traffic line search ranges.
